(19) United States
(12) Patent Application Publication
(10) Pub. No.: US 2006/0179664 A1
(43) Pub. Date: Aug. 17, 2006

(54) Tool for sectioning a worn end from a windshield wiper blade

(76) Inventor: Charles S. Butler, Linden, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/058,342

(22) Filed: Feb. 15, 2005

(51) Int. Cl. B26B 29/00

(52) U.S. Cl. 30/294

(57) ABSTRACT

A tool for sectioning an edge of a wiper blade having a body with a substantially elongated and rectangular shape with first and second ends and constructed from a hardened plastic material. An aperture being defined in the body in a lengthwise extending direction between the first and second ends, the aperture substantially matching a cross-sectional profile of the wiper blade. A depth adjustable blade contained within the body and in communication with the aperture, the blade further including a substantially “V” shaped notch defining first and second interconnected cutting edges centered relative to the aperture. The cutting edges intercept the edge of the wiper blade as it is drawn along the aperture and in order to section a portion therefrom.

### BACKGROUND OF THE INVENTION

1. Field of the Invention

The present invention relates generally to wiper blade trimming and sharpening devices and, more specifically, to a hardened and durable plastic housing which encloses a depth adjustable “V” shaped razor cutter in communication with a lengthwise extending aperture (modified T slot with a V-shaped descending groove pattern) matching a cross sectional profile of a windshield wiper blade. The “V” shaped razor is supported at opposite ends by a driving Allen set screw with fixed threaded adjustment and a slide pin and in order to adjust a depth of cut of a trailing rubberized edge of the wiper blade as it is traversed along the profile.

2. Description of the Prior Art

The prior art is documented with various types of blade cleaning, abrading and sectioning devices. The objective in each instance is typically to clean or sharpen an elastomeric edge associated with a wiper blade, squeegee or similar device.

U.S. Pat. No. 5,848,471, issued to Freeland, discloses a hand-held windshield wiper reconditioning device that has a body shaped and sized to be operated by a hand of a user. In an embodiment of the reconditioning device, a pair of opposing guide surfaces extends between a front face and a rear face of the body. The guide surfaces are shaped to define a channel through the body with a cross-sectional profile that substantially corresponds to a cross-sectional shape of a wiper blade. A cutting blade is mounted across an upper portion of the channel at an acute angle with respect to the cutting path. In operation, the channel positions the wiper blade to maintain a constant spatial relationship between the wiper blade and the body. As the body moves along the wiper blade, the cutting blade cleanly slices material from the tip of the wiper at a substantially constant depth along the whole length of the wiper.

U.S. Pat. No. 5,359,776, issued to Glazer, teaches a windshield wiper sharpening device for restoring the cleaning properties of worn vehicle wiper blades. A notch in the body of the hand-held device accepts the working edge of the windshield wiper blade. A sharp steel blade recessed in the notch is thus placed in transverse contact with the working edge of windshield wiper blade. As the device is drawn along the length of the windshield wiper blade, wiper blade material is removed as needed to restore its original sharp cross-section and smoothness.

U.S. Pat. No. 5,860,182, issued to Sareyani, teaches a hand-held windshield wiper blade cleaner device for sliding along the length of a windshield wiper blade. The device includes a resilient hollow, cylindrical shell which houses two cleaning strips forming a V-shaped groove. The wiper blade is accommodated within the V-shaped groove and the two legs of the shell are squeezed together and slid along the length of the blade to remove dirt therefrom. The device is optionally equipped with an ice-scraping ridge on one leg of the shell, and/or an absorbent cleaning ridge on the other leg of the shell, and insect-scraping grooves running along the base.

U.S. Pat. No. 6,322,266, issued to Traynor, teaches a windshield wiper blade cleaning device that includes a body for holding in the hand of a user and bristles extending from the body for cleaning the windshield wiper blade. The body includes a substantially channel-shaped, slender, elongated and has a web with an inner face and a pair of terminal ends. A pair of flanges extend from the web, each of which including an inner face, an outer face, and a pair of terminal ends. The inner face of the web has a length that axially tapers inwardly and upwardly at the pair of terminal ends of the web for facilitating insertion of the windshield wiper blade. The inner face of each flange axially diverges outwardly at the pair of terminal ends thereof and convexly upwardly along the length thereof for further facilitating insertion of the windshield wiper blade. The outer face of each flange axially diverges outwardly at the pair of terminal ends thereof and convexly upwardly along the length thereof for maximizing resiliency.

U.S. Pat. No. 3,708,924, issued to Prunchak, teaches a hand tool of pocket size for cleaning and reconditioning the wiping edge portion of a resin or rubberlike wiping blade for windows, such as of a motor vehicle. The tool includes a rigid operating head of an abrasive-lined surface V shape which is adapted to be moved along the wiping edge portion of a blade to remove adherent road grime and the like. A gripping handle is angled from the operating head to enable the operator to easily condition or clean a wiper blade that is in position in a substantially planar operating position with respect to the windshield of a vehicle by merely raising the blade slightly away from the windshield.

U.S. Pat. No. 4,617,765, issued to Weiler, teaches an edger for manually refurbishing elastomeric wiper blades and having a housing to be grasped by a user. The housing includes a groove with rigid, non-abrasive sidewalls spaced substantially the same as the width of the working edge of the blade, and an abrasive member disposed in the housing at the bottom of the groove, the abrasive member aligned transverse to the groove to remove material from the blade transverse and perpendicular to the blade, effectively smoothing the blade as the edger is passed along its edge. The abrasive member may be mounted in the bottom of an inverted T-shaped slot, or the housing may include a slotted external member and an internal member defining a flat surface for supporting the abrasive member behind the slot.

U.S. Pat. No. 3,670,459, issued to Welton, teaches a combined abrading, scraping and poking implement in the form of a hand tool having an abrasive surfaced channel for treating a wiper blade and further capable of cleaning dirt from a washer nozzle. A wire carried by a slider is movable between an operational position where an end portion of the wire protrudes from the tool and a stowed position within the confines of the tool and vice versa.

Finally, Siciliano, U.S. Pat. No. 5,426,895, teaches a windshield wiper blade cleaning device and having a channel for receiving the tip of a wiper blade. The channel has a frictional base for removing dirt from the tip of the blade as it is drawn longitudinally through the channel. In an alternate embodiment, the channel also has frictional walls for cleaning the sides of the blade. The base and/or walls are further made frictional by means of projections, filaments or abrasive materials.

### SUMMARY OF THE PRESENT INVENTION

The present invention discloses a tool for sectioning an edge of a wiper blade. The tool includes a three-dimensional, substantially elongated and rectangular shape body constructed of a hardened plastic material. An aperture is defined in the body in a lengthwise extending direction between first and second ends of the body. The aperture includes, in cross section, a modified T slot with a communicating and V-shaped descending groove pattern and which matches substantially a corresponding cross-sectional configuration of the wiper blade.

A depth adjustable blade is contained within the body and in communication with the aperture, and in particular its lower extending and V-shaped descending groove pattern. A cutting edge associated with the blade intercepts the edge of the wiper blade as it is drawn along the aperture and in order to section a portion thereof. In a preferred variant, the cutting edge is divided into first and second interconnected edges formed in a substantially “V” shaped notch and which is centered relative to the lengthwise extending aperture.

The depth adjustability of the blade is accomplished by a first aperture formed in the blade and seating a fixed and rotating set screw. Interengaging screw threads established between the set screw and blade allow for threaded adjustment of the blade in first and second depthwise extending directions. A tool accessible end of the fixed set screw is engaged by an Allen wrench, an elongated and arcuate recess defined in a surface of the body seating the Allen wrench in a press fit fashion.

A second aperture in the blade seats a fixed pin for providing stabilizing support to the depthwise adjustable blade at another location and in cooperation with the rotatable set screw. In use, the cutting edges intercept the edge of the wiper blade as it is drawn along said aperture and in order to section a portion therefrom.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an environmental view illustrating the hand-held sectioning tool in use with a wiper blade assembly according to the present invention;

FIG. 1A is a cutaway view taken along line 1A-1A of FIG. 1 and illustrating the cross-sectional profile of the elastomeric portion of the wiper blade;

FIG. 2 is an end cutaway view of the tool and illustrating the depth-adjustable blade sectioning subassembly;

FIG. 3 is an exploded illustration of the tool and showing in particular the depth-adjustable blade sectioning subassembly and illustrating a recess pocket for supporting an Allen wrench for actuating a set screw with fixed threaded adjustment and a slide pin and in order to adjust a depth of cut of a trailing rubberized edge of the wiper blade as it is traversed along the profile; and

FIG. 3A is an enlarged view of the cutting blade and illustrating its “V” notch configuration for sectioning an incremental edge portion of the associated and elastomeric wiper blade.

### DETAILED DESCRIPTION OF THE PREFERRED EMBODIMENTS

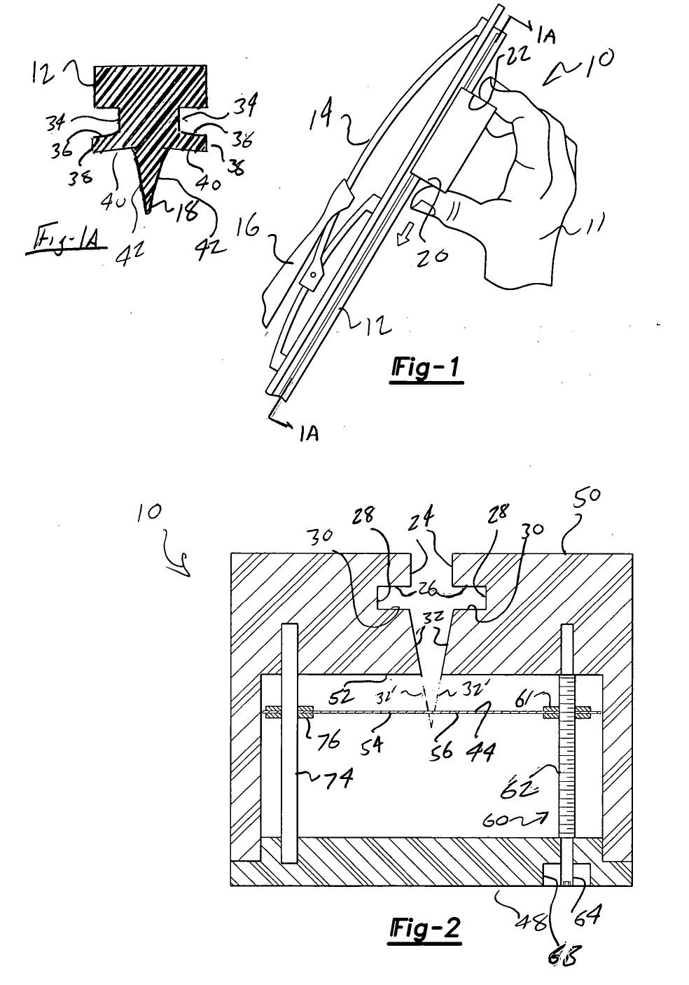

Referring now to FIG. 1, an environmental view is illustrated at 10 of a tool, portably held within a hand 11 of a user and for sectioning an edge of a wiper blade 12, and such as which is typically mounted to a supporting wiper assembly 14 in turn secured to a reciprocating arm 16 of a vehicle. As described previously, the present invention discloses a novel and improved mechanism for sectioning or shaving an iterative portion of a worn end of the wiper blade 12, see at 18 in FIG. 1A, and in order to maintain an effective contact edge for clearing ice, water

As best shown in the end cutaway illustration of FIG. 2, an aperture is defined in the tool body in a lengthwise extending direction between the first 20 and second 22 ends of the body. The aperture is defined by pairs of opposing interconnected, recessed and interiorly facing surfaces defined depthwise into the tool body and includes in cross section a modified T slot, see opposing interconnecting surface pairs 24, 26, 28 and 30.

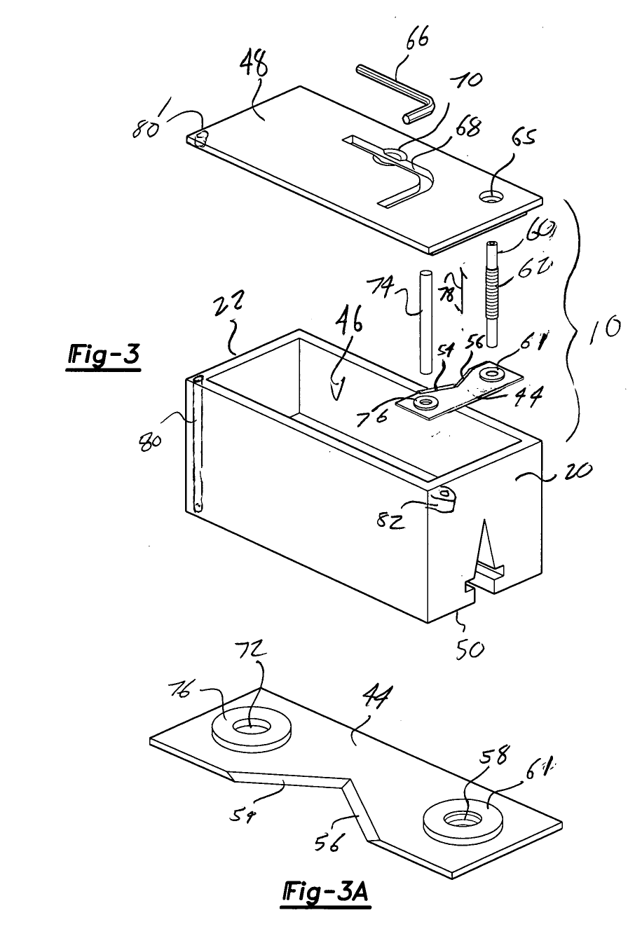

A V-shaped descending groove pattern (see surface pair 32) communicates with the opposing pair of surfaces 30 associated with a bottommost surface of the T-slot and matches substantially a corresponding cross-sectional configuration of the wiper blade 12 in FIG. 1A, and in particular its mirrored exterior facing surfaces 34, 36, 38, 40 and 42. As illustrated in each of FIGS. 2, 3 and 3A, a depth adjustable blade 44 is contained within an open interior of the tool body 10, and in communication with at least a bottommost descending portion of the V-shaped groove surfaces 32 (see as best shown in FIG. 2).

As is shown in the exploded view of FIG. 3, a substantial interior 46 of the tool body is open, this being defined between an assembleable cap 48 and a thickened bottom wall 50 (see again in FIG. 2) incorporating the various opposing and recessed surfaces 24, 26, 28, 30 and 32 and which communicates to the open interior 46 a bottommost portion of the descending groove surfaces (in phantom at 32′). In this fashion, the tool 10 of the present invention is capable of being adjusted to sever or excise a suitable portion of the wiper blade edge 18 (see FIG. 1A) up to a maximum amount (defined by underside surface 52 in FIG. 2) by which the wiper 12 will maintain sufficient effectiveness in use.

In use, a cutting edge associated with the blade 44 intercepts the bottommost projecting edge 18 of the wiper blade 44 as it is drawn along the lengthwise aperture and in order to section the desired portion 18 thereof (see again FIG. 2 cutaway). In a preferred variant, the cutting edge of the blade 44 is divided into first 54 and second 56 interconnected edges formed in a substantially “V” shaped notch and which is centered relative to the lengthwise extending aperture (see again lower converging edges 32′ in FIG. 2). As best shown in the enlarged sectional view of FIG. 3A, the angled cutting blade edges 54 and 56 are inwardly angled relative to one another and in order to maximize the cutting effect of the wiper blade edge 18 as it is drawn along the blade 44 by virtue of the translation of the tool body 10 by the user's hand 11.

Depth adjustability of the blade 44 is accomplished by a first aperture 58 formed at a first location in the blade through which is seated a fixed and rotating set screw 60. Outwardly directed and spiraling threads 62 associated with a central location of the set screw 60 interengage with internal threads defined in a disc element 60 secured to a facing surface of the blade 44 and in alignment with the aperture 58 to allow for threaded adjustment of the blade in first and second depthwise extending directions.

A tool accessible end 64 of the fixed set screw 60 (see also annular recess 63 in FIG. 2) is engaged by an Allen wrench 66 (FIG. 3). As again shown in FIG. 3, the set screw 60 is rotatably supported at 65 at an opposite end and by a recess formed in the cap 48. An elongated and arcuate recess 68 is defined in a surface of the body (such as in the assembleable cap 48) for seating the Allen wrench 66 in a press fit fashion. An enlarged and substantially bowl-shaped recess 70 is defined in a surface of the body in communication with the elongated recess and for facilitating removal of the Allen wrench 66 during its use.

A second aperture 72 in the blade 44 seats a fixed pin 74 for providing stabilizing support to the depthwise adjustable blade at another location and in cooperation with the rotatable set screw 60 (see also reinforcing disc element 76 in mating and securing engagement over a selected surface of the blade 44). In this fashion, the blade 44 is adequately supported in channeled fashion along a vertical path, see bidirectional arrow 78 in FIG. 3, between the fixed and rotatable set screw 60 and smooth exterior surfaced pin 74.

As further is shown in FIG. 2, the set screw 60 and pin 74 are secured at opposite ends to locations in both the upper and lower locations of the tool body 10. Other and additional features include the provision of a depthwise extending key ring hole, see at 80, 80′ or 82 in FIG. 3, such as which is capable of mounting the tool body 10 to a chain or key ring.

Having described my invention, other and additional preferred embodiments will become apparent to those skilled in the art to which it pertains, and without deviating from the scope of the appended claims:

1. A tool for sectioning an edge of a wiper blade, said tool comprising:
a three-dimensional shaped body having a length, width and thickness with first and second ends;
an aperture defined in said body in a lengthwise extending direction between said first and second ends, said aperture substantially matching a cross-sectional profile of the wiper blade; and
a depth adjustable blade contained within said body and in communication with said aperture, a cutting edge associated with said blade intercepting the edge of the wiper blade as it is drawn along said aperture and in order to section a portion therefrom.

2. The tool as described in claim 1, said body having a substantially elongated and rectangular shape and comprising a hardened plastic material.

3. The tool as described in claim 1, said blade further comprising a substantially “V” shaped notch defining first and second interconnected cutting edges centered relative to said aperture, at least a portion of a volumetric interior of said body being hollowed to facilitate vertical adjustment of said blade.

4. The tool as described in claim 1, said blade further comprising a first aperture for seating therethrough a fixed and rotating set screw, interengaging screw threads established between said set screw and blade allowing for threaded adjustment of said blade in first and second depthwise extending directions.

5. The tool as described in claim 4, further comprising a second aperture in said blade and through which is seated a fixed pin for providing stabilizing support to said depthwise adjustable blade.

6. The tool as described in claim 4, further comprising a tool accessible end of said fixed set screw engaged by an Allen wrench, an elongated and arcuate recess defined in a surface of said body and for seating said Allen wrench in a press fit fashion.

7. The tool as described in claim 1, said lengthwise extending aperture having a specified shape and size and further comprising a modified T slot with a communicating and V-shaped descending groove pattern.

8. The tool as described in claim 1, said body having a specified shape and size and further comprising a depthwise extending key ring hole.

9. The tool as described in claim 5, further comprising an interiorly threaded disc element aligning with said first aperture and securing to a selected face of said blade.

10. The tool as described in claim 9, further comprising a further reinforcing disc element aligning with said second aperture and securing to a selected face of said blade.

11. The tool as described in claim 6, further comprising an enlarged and substantially bowl-shaped recess defined in a surface of said body in communication with said elongated recess for facilitating removal of said Allen wrench.

12. A tool for sectioning an edge of a wiper blade, said tool comprising:
a body having a substantially elongated and rectangular shape with first and second ends, said body further comprising a hardened plastic material;
an aperture defined in said body in a lengthwise extending direction between said first and second ends, said aperture substantially matching a cross-sectional profile of the wiper blade; and
a depth adjustable blade contained within said body and in communication with said aperture, said blade further comprising a substantially “V” shaped notch defining first and second interconnected cutting edges centered relative to said aperture, said cutting edges intercepting the edge of the wiper blade as it is drawn along said aperture and in order to section a portion therefrom.

13. A tool for sectioning an edge of a wiper blade, said tool comprising:
a body having a substantially elongated and rectangular shape with first and second ends, said body further comprising a hardened plastic material;
an aperture defined in said body in a lengthwise extending direction between said first and second ends, said aperture substantially matching a cross-sectional profile of the wiper blade;
a depth adjustable blade contained within said body and in communication with said aperture, said blade further comprising a substantially “V” shaped notch defining first and second interconnected cutting edges centered relative to said aperture;
a first aperture in said blade seating a fixed and rotating set screw, interengaging screw threads established between said set screw and blade allowing for threaded adjustment of said blade in first and second depthwise extending directions;
a second aperture in said blade seating a fixed pin for providing stabilizing support to said depthwise adjustable blade;
said cutting edges intercepting the edge of the wiper blade as it is drawn along said aperture and in order to section a portion therefrom.
